(19) United States
(12) Patent Application Publication
(10) Pub. No.: US 2010/0102985 A1
(43) Pub. Date: Apr. 29, 2010

(54) RECEIVER ORIENTATION IN AN ELECTROMAGNETIC SURVEY

(75) Inventors: David Ridyard, Sugar Land, TX (US); Mark J. Wilkinson, Hemstead, TX (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: ELECTROMAGNETIC GEOSERVICES ASA, Trondheim (NO)

(21) Appl. No.: 12/443,189

(22) PCT Filed: Sep. 24, 2007
(86) PCT No.: PCT/GB2007/003613

§ 371 Date: Dec. 30, 2009

(30) Foreign Application Priority Data
Sep. 29, 2006 (GB) 0619272.8

(51) Int. Cl. H04B 13/02; G01V 3/08; G01V 1/20; G01V 1/00

(52) U.S. Cl. 340/852; 340/853.8; 367/14; 340/854.1

(57) ABSTRACT

A system for determining the position and/or orientation of electromagnetic receivers in a network of receiver instruments at a remote location, a first receiver instrument including one or more electromagnetic sensors, the system comprising transmitting means to send a characteristic signal, detecting means to detect transmitted signals from a plurality of receiver instruments, depth measurement means to measure the depth of the first instrument, recording means to store data from the transmitting means, the detecting means and the depth measurement means, and processing means for processing data from the receiver instruments.

### PRIORITY CLAIM

The present application is a National Phase entry of PCT Application No. PCT/GB2007/003613, filed Sep. 24, 2007, which claims priority from Great Britain Application Number 0619272.8, filed Sep. 29, 2006, the disclosures of which are hereby incorporated by reference herein in their entirety.

### TECHNICAL FIELD

The invention is directed towards a method and apparatus for determining the position and orientation of electromagnetic receivers. The receivers may be deployed on instruments for use in surveys, particularly for use in electromagnetic surveys where a high degree of accuracy of location and orientation are required, for example 3D surveys.

### BACKGROUND

Traditional hydrocarbon exploration and production methods rely on the use of reflected seismic waves to create images of the subsurface. Where these images indicate structures with a high probability of sustaining a hydrocarbon reservoir, the reservoir is tested with drilling. Although the arrival of 3D seismic imaging over the last 30 years has increased the success rate of the technique, the rate of failure (“dry holes”) remains unacceptably high, particularly in the exploration phase. The cost of drilling a hole may be upwards of US$30 m and it is therefore desirable to minimize the number of “dry holes” drilled. Furthermore, the accurate measurement of “reserves in place” remains problematic in many environments.

Electromagnetic techniques offer a critical piece of additional information to exploration and production companies. Electromagnetic-based images of the subsurface can be used to locate and define high resistivity bodies. These bodies can directly indicate the presence of hydrocarbon reserves, but can also be used to complement seismic images by accurately describing complex, acoustically opaque structures formed by salt intrusion, volcanic activity etc. Since the electromagnetic technique describes subsurface variations in terms of resistivity, in much the same way as a wireline “well log” this technique is often referred to as Seabed Logging, although this technique offers significant increases in spatial scope, at the expense of some spatial resolution, relative to traditional in-well techniques.

The most common electromagnetic method in commercial use today uses electromagnetic sensors (receivers) placed on the seafloor, together with variations in the electric and often the magnetic fields. The source of the magnetic fields could be passive/solar (Magneto Telluric (MT)) or active (Controlled Source Electromagnetic (CSEM)), using a number of source signature strategies (continuous, coded, impulsive etc.). Data is typically recorded in a data logger built into the receiver node, and retrieved and processed when the receiver or node is recovered after the survey has been completed. The location of the receivers or nodes must be known to enable accurate subsurface imaging. Furthermore, since the electric and magnetic fields are 3D vector quantities, it is also necessary to understand the orientation of the receiver antennae.

Electromagnetic techniques have already proven significant value in a 2D imaging mode, but, as with 2D seismic, 2D Electromagnetic does not provide a fully accurate, spatially correct image of the subsurface.

According to one method, deployed receiver nodes are typically positioned using a short baseline acoustic system, with an acoustic transponder mounted on the node of each receiver, and another transponder mounted under the hull of the deployment vessel. In combination with attitude sensors mounted on the vessel, this results in a vector (range and azimuth) measurement of the location of the receiver node relative to the vessel whose position at the time of the measurements is known through, for example, GPS. However, this approach has two significant drawbacks.

Firstly, the accuracy of the measurement is limited due to inherent restrictions of acoustic technology (for example, ray bending due to thermoclines etc.) as well as the uncertainty associated with measurement of the attitude of the vessel (gyro, pitch, roll etc.). Since the position of each receiver is determined in this way there are a large number of variables and errors which combine when determining the relative position of each receiver or instrument in the network. As a result, the accuracy in the overall network is typically considered to be no better than 1-2% of water depth which will not be acceptable for 3D surveys in deep water.

Secondly, in order to position a receiver, the deployment vessel must wait until the receiver or node has settled on the seabed before determining the final position, and then moving on to deploy the next receiver. Allowing for 10 minutes to physically deploy a receiver, and then a fall rate of 1 m/s, results in a total deployment time of approximately 30 minutes for a receiver in 1000 m of water. This is a significant period of time when considering dropping upwards of 100 receivers for a survey, as would preferably be the case for a 3D survey.

### SUMMARY OF THE INVENTION

Embodiments of the invention can increase the accuracy of determining the position and/or orientation of each electromagnetic receiver and also reduce the time taken to deploy and accurately identify the position of each receiver instrument.

According to an embodiment, a system is provided for determining the position and/or orientation of electromagnetic receivers in a network of receiver instruments at a remote location, in which each instrument includes one or more electromagnetic sensors; transmitting means to send a characteristic signal, detecting means to detect transmitted signals from second and further instruments, means to measure the depth of the instrument; and recording means to store data from the transmitting means and the detecting means and the depth measurement means, the system further comprising processing means for processing the data from the instruments.

The invention also extends to a method of determining the position and/or orientation of electromagnetic receivers in a network of receiver instruments deployed in a remote location, in which: a first instrument transmits a characteristic signal and the instrument records the transmission and time of transmission; surrounding instruments receive the characteristic signal of the first instrument and record the nature and time of the signal in recording means; the depth of the instrument is determined; and the data from the instruments is forwarded to a central computing means where relative positions for each instrument are determined; the method further comprising the step of determining the absolute position of one or more instrument, forwarding this information to a central computing means and thereby calculating the exact position of each of the instruments in the network.

The invention may be applicable to determining the position of electromagnetic receivers or sensors for use in a Seabed Logging survey. For such 3D surveys, a grid of receiver instruments is deployed on the seabed. Each instrument may have one or more electromagnetic receivers attached to it, for example four receivers arranged at 90° to each other. If the range or distance from each instrument to at least two other instruments can be measured, and provided that the water depth is known at each instrument, then it is possible to accurately compute the location of each receiver instrument relative to the others. In one embodiment, the distance or range to three or more instruments is measured in addition to a depth measurement. The depth of each instrument may be measured by an altimeter or may be determined from bathymetry.

### DETAILED DESCRIPTION

In embodiments, multiple measurements of each range are made, and more than three ranges per instrument are measured, since this will provide redundancy in the measurement network. Each instrument records data from any signal which has been received from any other instruments in the network. If the acoustic conditions are good, and the instrument spacing is small, a single instrument may measure signals from 20-30 instruments and determine the range to each of these instruments. At the corners of the network, there may only be three immediate neighbours and if acoustic conditions are poor there may only be a few measurements recorded.

Redundancy in the network may have many benefits. Firstly, it may allow a solution to be calculated even when some of the elements in the network fail which may happen when operating in areas of high seafloor ruggedness where there may be obstacles between some instruments. Secondly, it may improve the accuracy of the solution through the use of least mean squares analysis or other statistical tools on the calculations.

Thirdly, it may allow for the verification of the velocity used for propagation of sound in water. Once all the observed ranges have been used to compute relative positions, the computed positions can then be used to back compute the “perfect” or computed ranges. The difference between the computed range and the observed range is known as the residual. If all the residuals are positive, then the observations are all too small, implying the velocity used is too low. Alternatively, if all the residuals are negative, then the velocity is too high. It is then a simple exercise to compute a revised velocity such that there are as many positive residuals as negative residuals. In some sophisticated network adjustments, with a reasonable level of redundancy, the velocity is treated as an unknown, and is computed directly in the adjustment. Fourthly, redundancy in the network may allow estimation of the accuracy of the network.

The measurement of the ranges allows accurate calculation of the relative geometry of the instruments in the network. This is very important for 3D surveys. In order to provide an even more detailed 3D electromagnetic image of the survey area it is necessary to obtain the absolute position of each instrument and therefore each EM receiver. An additional step may therefore be required. At some point during the deployment process or during the subsequent survey, the absolute position of a minimum of two instruments in the grid may be measured. This may be accomplished using traditional vessel mounted short baseline positioning techniques (for example, USBL) either as the vessel traverses the survey area deploying receivers, or after receiver deployment is completed. As with the range or distance measurements within the seabed network, it is desirable to improve and estimate the accuracy of the absolute solution through the use of redundant observations. It is therefore preferred to measure the absolute position of more than two instruments.

By measuring the absolute positions of N instruments, each having an absolute Gaussian error of X meters, the network adjustment will cause the final solution to have errors of X/(N)^{1/2} thereby minimising any error from the measurements. Secondly if a small number of instruments are being positioned on the seafloor, it may be practical to use a USBL type system more diligently. A process called “sailing a box” around the instrument may be used. In this case, the deployment vessel sails around each instrument several times, both clockwise and anti-clockwise. By positioning from each side of the “box,” many of the errors in the USBL cancel out, resulting in much improved accuracy. The problems with accuracy of the measurements of absolute position which have been encountered previously are therefore minimised. Further, as stated previously, the most important measurement for the generation of a 3D picture is the relative position of each receiver and according to the method of this invention this is determined without reference to the vessel on the sea surface.

Seabed EM receivers for 3D surveying are typically deployed on instruments arranged in a grid of substantially perpendicular columns and rows on or near the sea floor with spacing between adjacent instruments of between 500 m and 10 km, for example 1-8 km, 2-6 km or 3-5 km. For efficient operations to fully map the area being surveyed, minimum grids of 10×10 to 20×20 may be deployed and the spacing will depend partly on the size of the area to be surveyed and partly on the level of detail required. Naturally, the further apart the instruments are from each other, the more interpolation of data there is between instruments.

From an acoustic positioning perspective, the higher the distance between adjacent instruments, the more difficult the system is to operate. For example, where the instruments are separated by 10 km in the grid ranges must be reliably obtained up to 14 km (the distance to a “diagonally” adjacent instrument being √2×distance to “horizontally” or “vertically” adjacent instrument).

In the presence of an undulating or rugged seafloor, it is desirable to achieve direct line of sight range observations between adjacent instruments. With distances of up to 14 km being possible, there is considerable opportunity for substantial variations in the height or curvature of the sea floor. For example a ridge, or a boulder, between instruments could prevent or distort measurements being made and cause a problem. This is very hard to quantify and is a reason why redundancy in the measurements is preferred. In many cases, details of topographical variations will only become apparent as the measurements from the receivers are taken.

In order to maximise the likelihood of having a direct line of sight between instruments from which acoustic measurements can be taken, the transmitters and acoustic sensors (and possibly therefore also the electromagnetic receivers) may be elevated by a predetermined distance above the sea floor. The distance may be of the order of 0.5 to 5 m, preferably 1 to 3 m or more preferably 1-2 m although substantially greater elevations may be required in some cases, for example when using vertical electric antennae. If the transmitters, acoustic receivers and optionally the electromagnetic receivers are positioned a pre-determined distance away from the sea floor, this can be accounted for in positioning data processing software and algorithms when analysing the data.

The characteristic signal sent from a transmitter can be an acoustic signal. Such a signal does not interfere with the electromagnetic receiver or sensor. The 14 km or more range requirements results in the preferred use of advanced technology in order to minimize errors due to “multi-pathing”. Multi-pathing is the reception of acoustic signals that have traveled by an indirect route from transmitter to receiver—typically reflections off the sea surface or the seabed or large man-made structures such as ships or oil field production platforms. These multi-pathed signals are usually subject to some distortion and/or dispersion, which allows them to be eliminated through the use of signal processing techniques.

Spread spectrum “coded” transmissions, such as CHIRPS, may be used as the acoustic signal. This also has the advantage of providing the ability for multiple range observations to be made simultaneously, with reduced risk of misidentification of acoustic signals.

Range accuracy requirements need to be defined based on analysis of (a) the sensitivity of EM imaging to positioning errors and (b) the minimum geometric redundancy available for the survey and area in question.

In one embodiment, the acoustic signals should support two or more identifiable signatures, such as a coded CHIRPS signal, for example a binary system with an “up sweep” waveform (binary ‘1’) and a “down sweep” waveform (binary ‘0’). With the identifiable signatures defined, each individual unit can provide a unique and readily identifiable signature based on transmitting an extended sequence. This signature can then be identified uniquely by correlation at the receiver side of each of the adjacent receivers. For a signature comprising two CHIRPS, four unique addresses are possible (00, 01, 10 and 11) for three CHIRPS, eight unique addresses are possible (000, 001, 010, 011, 100, 101, 110 and 111) etc. For a SBL application, thousands of unique addresses can be accommodated (for example, 2048 unique addresses may be obtained by using eleven CHIRPS/bits). In addition, the transmission coding format can support several bits to allow for error checking.

For an eleven CHIRP signal the characteristic signal for each receiver will be quite long—of the order of 1 second (50 mS×16). While this may not normally be acceptable for dynamic applications such as seismic streamer tracking or ROV (Remotely Operated Vehicle) command and control, for a static application such as Seabed Logging receiver positioning, these delays present no problems.

In one embodiment of the present invention, the acoustic measurement is achieved by measuring the flight time of an acoustic pulse transmitted from one instrument, and received by another. The range is then obtained by dividing the measured time by the velocity of sound in water. However, this embodiment requires accurate synchronization of clocks which may not be cost effective with a large number of instruments.

Therefore, according to another embodiment of the present invention, the acoustic measurement is achieved by measuring the “round trip” flight times. In this case, a first instrument transmits a characteristic signal. When an adjacent instrument receives the signal, it waits a predetermined delay time, and then responds with a characteristic signal of its own. The first instrument then measures the total round trip travel time, removes the known delay before the second characteristic signal was sent, and divides the remaining time by two to compute the one way travel time. This method avoids the requirement for synchronisation of the clocks on each instrument which may be a difficult and time consuming task if there are more than 100 instruments and the timing must be accurate to within 1 ms or better.

According to a further embodiment of the present invention in the case where there is no synchronization of clocks, and where it is not possible to transmit from the seabed device, one or more standalone transmitters may be used to transmit pulses synchronously. When the arrival time differences are measured at two instruments, this information can be used to indicate how much further from the transmitter one instrument is relative to the other. This results in a hyperbolic line of position rather than a circular line of position as would be the case for a range measurement. Hyperbolic lines of position are harder to handle and require more redundancy, but from these measurements it is possible to determine the relative positions of the instruments in the network.

Determination of the position and/or orientation can be accomplished as soon as possible after completion of deployment of the receiver instruments in one embodiment. The positioning hardware on each instrument can be deployed in a “listen” mode, consuming the minimum amount of power. Once the receiver instruments are all deployed, the vessel can send a “wake-up” command to one or more instruments, which will then start the range measurement process. As each instrument receives an interrogation from the vessel or from another instrument, it can immediately star its own transmission sequence. In this way, it is not necessary for the deployment vessel to traverse the entire grid of receiver instruments again to wake them up. Alternatively the “wake-up” command for one or more of the receivers may be from a timer on one or more instruments which is programmed to trigger the emission of a first signal at a predetermined time.

Once each instrument has measured ranges to all possible neighbours (namely it has received a first characteristic signal from each of the surrounding instruments and it has received signals back from each of its neighbours in response to its own characteristic signal), it may go back into “listen mode”, in order to (a) minimize battery and power consumption, and (b) eliminate interference with the EM signal measurement. Before returning to the listen mode, the instrument can communicate its range measurement to each of its neighbours. Eventually, this process will lead to all instruments having knowledge of all ranges to other instruments. At this time, the vessel can collect all the ranges from any point in the seafloor network. Therefore, each instrument can be equipped with suitable intelligence and data storage capability to gather data and re-transmit this to adjacent instruments and/or to the vessel.

In order for an improved 3D image to be produced it is also desirable to accurately determine the orientation of each electromagnetic receiver to with about 1.5 degrees. EM receiver orientation has traditionally been derived from the electromagnetic data which is recorded as the EM source passes over each EM receiver. However, with the increasing number of EM receivers used for 3D surveys, it may not be practical or efficient to have the source passing directly over each EM receiver and therefore this method of determining the orientation of each EM receiver may not be appropriate. It is therefore a further aspect of the present invention that the means for determining the position of the EM receiver instruments are also used for determining the orientation or the EM receivers. In particular, acoustic sensors or receivers may be placed adjacent to electromagnetic sensors on each receiver instrument to accurately determine the relative positions of each electromagnetic sensor and therefore the orientation of the receiver.

If acoustic sensors or hydrophones are placed on the instruments at the tips of the antennae of the receiver node, these hydrophones can detect the signals which are subsequently used for positioning. Once the positions of the EM receivers (which are also acoustic transmitters) are known, the time or phase difference observed between each sensor pair can be used to determine the orientation of the EM sensor antennae.

As a minimum, any two acoustic transmitters may be sufficient to provide unambiguous orientation determination. In practice, and as for the determination of relative position, redundancy is desirable to improve the accuracy of the solution, and to provide a quality control metric for the solution derived.

In one embodiment of this aspect of the present invention, the determination of the relative position of each receiver instrument is treated as a completely independent system of the EM receivers, with its own transmitters and receivers (for example acoustic sensors) mounted a meter or two above the base plate. In this case, the positioning transmitters may also be used for determining the orientation, but additional tip mounted hydrophones are used to measure the signals for EM receiver orientation determination.

In a second embodiment of this aspect of the present invention, tip mounted receivers (for example acoustic sensors) may be used for positioning and orientation determination. Using this arrangement, there is a substantial increase in the redundancy of the positioning solution, but there may be some risk of loss of acoustic range capability, since the antenna tips are very close to the seafloor, increasing the risk of line of sight blockage.

For orientation determination, it is possible to process each acoustic sensor or hydrophone fully, as in the receiver instrument positioning system described above. However, since the hydrophones receive essentially the same signals, with very small time shifts, some cost could be saved by using analogue correlation techniques to accurately determine phase differences. Whether the processing is performed analog or digital, a quality metric based on the amplitude of the signal and the correlation co-efficient should be recorded. These metrics can be used to weight observations used in a least mean squares adjustment. The quality metric may be an amplitude measurement of the received signal (in addition to the time received and the identifying characteristic) and/or it may be the accuracy of the correlation against an expected signature. This quality metric can then be used to weight each measurement in the calculation of the network position or orientation.

For the embodiment where the orientation system is implemented as part of the positioning system, each device may record and save a data package of the following general form which can then be sent to a central processing unit:
Number of instruments from which good quality signals received (<3 represents an error condition)
For each instrument from which usable acoustic signals are detected
   Instrument ID for signal received
   Range to instrument from which signal received
   Time difference (S1-S2)
   Time difference (S1-S3)
   Time difference (S1-S4)
   Time difference (S1-Sn)
   Quality metric: Range to instrument
   Quality metric: Time difference (S1-S2)
   Quality metric: Time difference (S1-S3)
   Quality metric: Time difference (S1-S4)
   Quality metric: Time difference (S1-Sn)
      where S1-Sn are the individual hydrophones or acoustic sensors mounted on the receiver instrument. For example, S1-S4 might be on the tips of the EM antennae arranged at substantially 90° to each other, and S5 might be mounted above the antenna base plate. In one embodiment, two or more sensors can be rigidly attached above the base plate to enable measurement of the magnetic sensors independently of the electric sensors. In some cases each range or time difference may be measured and recorded several times to increase redundancy.

The position of the electromagnetic source is also important in order to produce a 3D map of the area being surveyed. Traditionally, this is done using vessel based short baseline acoustic systems and these can be used in 3D systems as well. However, as the speed of deployment increases a more accurate means of dynamic positioning of the source may be required. The present invention also extends to the use of the system to accurately determine the position of the electromagnetic source.

A system according to an embodiment of the present invention may include a computer including at least one data processor and a computer readable medium programmed with instructions. A method according to an embodiment of the present invention may include utilizing a computer.

1. A system for determining the position and/or orientation of electromagnetic receivers in a network of receiver instruments at a remote location, a first receiver instrument including one or more electromagnetic sensors, the system comprising:
transmitting means to send a characteristic signal;
detecting means to detect transmitted signals from a plurality of receiver instruments;
depth measurement means to measure the depth of the first receiver instrument;
recording means to store data from the transmitting means, the detecting means, and the depth measurement means; and
processing means for processing data from the receiver instruments.

2. The system of claim 1, wherein the transmitting means is a source for a transmission of an acoustic signal.

3. The system of claim 1, wherein the first receiver instrument further includes command means for activating a transmission.

4. The system of claim 3, wherein the command means is a signal received from a vessel.

5. The system of claim 3, wherein the command means is a timer positioned on the first receiver instrument.

6. The system of claim 3, wherein the command means is a detection of a signal from a second receiver instrument.

7. The system of claim 1, wherein the detecting means comprises an acoustic receiver or a hydrophone.

8. The system of claim 1, wherein the first receiver instrument includes at least two electromagnetic receivers.

9. The system of claim 8, wherein the network of receiver instruments is deployed on a sea floor.

10. The system of claim 9, wherein the receiver instruments comprise means to sit a distance d above the sea floor.

11. The system of claim 1, wherein the depth measurement means comprises an altimeter.

12. A method of determining a position and/or an orientation of electromagnetic receivers in a network of receiver instruments deployed in a remote location the method comprising:
transmitting a characteristic signal with a first of the receiver instruments;
recording a transmission and a time of transmission with the first of the receiver instruments;
receiving the characteristic signal of the first of the receiver instruments with at least a second of the receiver instruments;
recording a nature and a time of the characteristic signal in recording means with at least the second of the receiver instruments;
determining a depth of the first of the receiver instruments;
forwarding data from at least the first and second receiver instruments to a central computing means where a relative position for each of at least the first and second receiver instruments are determined;
determining an absolute position of at least one of the receiver instruments;
forwarding information corresponding to the absolute position of the at least one of the receiver instruments to a central computing means; and
calculating a position of each of the receiver instruments in the network.

13. The method of claim 12, wherein each of the receiver instruments has a clock synchronized with each other to record times of transmission and detection.

14. The method of claim 12, further comprising:
receiving a transmitted signal with at least one of the receiver instruments;
responding to the transmitted signal with a second characteristic signal after waiting a predetermined time; and
recording a time of arrival of the second characteristic signal with the first of the receiver instruments.

15. The method of claim 12, further comprising:
using one or more standalone transmitters to transmit pulses asynchronously;
recording an arrival time of at least one of the pulses at each of the receiver instruments;
sending data corresponding to the arrival time to a central processing means; and
calculating a distance between two receiver instruments.

16. The method of claim 12, wherein the characteristic signal is an acoustic signal.

17. The method of claim 16, wherein the acoustic signal is a coded signal.

18. The method of claim 17, wherein the coded signal is a CHIRPS waveform.

19. The method of claim 12, wherein determining the depth of the first of the receiver instruments comprises using an altimeter.

20. The method of claim 12, wherein determining the absolute position of the at least one of the receiver instruments comprises using a short baseline acoustic system.

21. The method of claim 12, further comprising measuring the absolute position of three or more of the receiver instruments.

22. A method of determining an orientation of each electromagnetic receiver in a network of receiver instruments deployed in a remote location, two or more acoustic sensors being arranged around a perimeter of each of the receiver instruments, the method comprising:
transmitting a characteristic signal with a first of the receiver instruments;
recording a transmission and a time of transmission with the first of the receiver instruments;
receiving the characteristic signal of the first instrument with the acoustic sensors of at least a second of the receiver instruments;
recording a time of receipt of the characteristic signal in recording means with at least the second of the receiver instruments; and
forwarding data from each sensor of the first of the receiver instruments to a central computing means and determining an orientation of the first of the receiver instruments by time or phase differences between signals received at each acoustic sensor.

23. The method of claim 22, further comprising using the acoustic sensors of the first of the receiver instruments to determine a position of the first of the receiver instruments.

24. The method of claim 23, wherein the acoustic sensors of the first of the receiver instruments are located adjacent to at least one of the electromagnetic receivers.

25. A method of determining a position and an orientation of electromagnetic receivers in a network of receiver instruments deployed in a remote location, two or more acoustic sensors being arranged around a perimeter of each of the receiver instruments, the method comprising:
transmitting a characteristic signal with a first of the receiver instruments;
recording a transmission and a time of transmission with the first of the receiver instruments;
receiving the characteristic signal of the first of the receiver instruments with the acoustic sensors of at least a second of the instrument receivers;
recording a time of receipt of the characteristic signal in recording means with the acoustic sensors of at least the second of the instrument receivers;
determining and recording a depth of the first of the receiver instruments; and
forwarding data from each sensor of the first of the receiver instruments to a central computing means, determining a relative position of each of the receiver instruments, and determining an orientation of each of the receiver instruments by time or phase differences between signals received at each acoustic sensor.

26. The method of claim 25, further comprising:
determining an absolute position of at least one of the receiver instruments;
forwarding information corresponding to the absolute position of the at least one of the receiver instruments to a central computing means; and
calculating an exact position of each of the receiver instruments in the network.
